(19) United States
(12) Patent Application Publication
(10) Pub. No.: US 2003/0217259 A1
(43) Pub. Date: Nov. 20, 2003

(54) Method and apparatus for web-based secure email

(76) Inventors: Ping Wah Wong, Sunnyvale, CA (US); Hugh Phu Nguyen, San Jose, CA (US)

Correspondence Address: Ping Wah Wong, 1443 Knowlton Drive, Sunnyvale, CA, 94087, US

(21) Appl. No.: 10/146,598

(22) Filed: May 15, 2002

(51) Int. Cl. H04L 9/00

(52) U.S. Cl. 713/153

(57) ABSTRACT

An end-to-end secure web-based email system is disclosed. The system uses a non-transient cryptographic engine and a web browser on the client side, which communicates with a server from the service provider. The server provides standard web-based email functions, whereas the non-transient cryptographic engine provides security functions including encryption, decryption, signature addition and verification. The non-transient cryptographic engine works with the web browser on the client side where the web browser acts as the user interface to the non-transient cryptographic engine. The non-transient cryptographic engine also provides a range of key management functions on the client side. The system is end-to-end secure because all the security functions are executed on the client side. The system has a graceful degradation property in that if a user does not carry the non-transient cryptographic engine, the user can still send and receive normal unsecured email service.

### BACKGROUND OF THE INVENTION

1. Field of the Invention

This invention relates to methods for sending, receiving and managing web-based secure electronic messages.

2. Background Description

The art of exchanging electronic messages, commonly called emails, has been practiced for many years. Email client applications exist for many computer platforms including Unix, Windows, Macintosh, and others. A new form of email is web-based email, where a web browser is used for reading, composing, sending, receiving, and managing email messages. Examples of web-based email services include hotmail, yahoo mail, etc. In web-based email, a user does not need to have email client software installed on the local computer. Instead, the user directs a web browser to a web-based email web site, and then manages, sends and receives the messages using the web browser while staying online. The messages are all processed on the server side at the email service web site. The web browser on the client side only serves as input and display mechanisms for the emails. An important advantage of web-based email is that a user can send and receive email messages on any computer, such as on public machines that are found in libraries, Internet Cafes, at school, at a friend's house, etc. Web-based email is operating system independent and it will work as long as there is a web browser on the computer.

Ordinary email is not secure because the message content is transmitted in clear text. It is possible for an eavesdropper or a system administrator to read the content of emails in the email accounts of other people. Cryptography is a method for securing email messages. Since secure emails are encrypted during transmission, only the intended recipient who has an appropriate decryption key will be able to decrypt and read the original content. There exist various secure email methods that provide security capabilities including encryption, decryption, digital signature insertion, and verification. These methods use either S/MIME and OpenPGP, which are the two major secure email protocols that are in use.

Today there are several commercial vendors providing web-based secure email services. Existing web-based secure email services can be classified into two categories of approaches. The distinguishing characteristic of these two categories resides in where the security operations (encryption, decryption, signature addition and verification) are performed. In one category, the security operations are performed on the server side, i.e., at the site of the email service provider. In another case, special software is used on the client side to perform the security operations.

US patent application US2002/0004899 A1 discloses a system where a proxy server is put at the server side between the Internet and the email server. The proxy server contains a means to perform security operations. This method falls into the first category where the security operations are performed at the server side. This system has a drawback in that it is not end-to-end secure. Since the email messages are sent from the user's computer to the proxy server in plain text, it will be possible for the proxy administrator to read the email content of the users. The email is also not secure from those eavesdroppers who have the capability to wiretap at locations between the user's computer and the email server. At the receiving side, similar problem occurs because a received secure email is decrypted at the proxy server and then the plain-text message is transmitted to the user. Examples of this approach include ziplip.com, mailsafe.org, quantimail.com and zixmail.net.

Hushmail.com is a web-based secure email service that falls into the second category, i.e., the security operations are performed at the client side. Hushmail.com provides a web-based secure email service that uses a java applet to perform security operations. Every time a user logs into the web-based system, a java applet is downloaded from the server to the user's browser. This applet is subsequently used for performing security operations at the client side. Although the hushmail.com solution is end-to-end secure in that the messages are transmitted in encrypted form to and from the client, there are significant drawbacks. First a java applet is transient in nature. Every time a user logs in to the service, a java applet needs to be downloaded. As a result there is significant waiting time at every login before the secure email service is functional. Second, java applets consist of intermediate codes (commonly called byte codes) that are interpreted by a java engine on the client computer. The fact that byte code is interpretive in nature implies that java applets execute slower than natively compiled code. Third, java applets require that a runtime java engine is already installed on a computer so that the byte code can be executed. This is a problem because some operating systems or browsers do not always come with a java engine pre-installed.

U.S. Pat. No. 6,356,937 describes a full-featured email system that allows the user to process email messages both off-line and on-line. The system requires a server application and a personal computer email application. The personal computer email application incorporates the logic of handling emails, which allows a user to process emails when the user is off-line. The personal computer email application supports traditional email features as well as security features such as encryption and decryption. The secure feature uses S/MIME and requires a user digital certificate for authentication. This system is interoperable in the sense that a user can either process the email both on-line and off-line. This approach requires a specific personal computer email application, and that means a user cannot just go to, for example, a public library and expect that the personal computer email application will be available.

US patent application publication US2001/0037315 A1 discloses a system for secure delivery of information via email. Specifically, it deals with financial information where an email server will transmit the complete financial information if an email connection is deemed to be secure, and only transmit partial information if an email connection is decoded to be less than secure. In this method, security is interpreted as whether or not the user is a participant of the system, i.e. where the email address of the user is recognized by the system. In other words, this disclosure does not address the use of cryptography to secure email messages.

There is a need for a web-based secure email method that can provide end-to-end security, that is non-transient in nature (i.e., does not require downloading cryptographic software when a user signs in), that does not require a local personal computer email application incorporating the logic of processing emails, and that does not require the use of a personal certificate.

### SUMMARY OF THE INVENTION

This invention provides a web-based secure email system that provides end-to-end security to the users. The system uses an email server on the server side, and a non-transient cryptographic engine on the client side to handle security operations including encryption, decryption, digital signature and verification, as well as key management. The cryptographic engine is non-transient in that it is a device connected to the computer on the client side to provide the cryptographic capabilities. As a result, there is no need to download the cryptographic software when a user logs into the service.

The non-transient cryptographic engine works with a web browser on the client side where the web browser provides a user interface mechanism for the web-based secure email service. The email logic is implemented on the server side. The system can handle ordinary plain-text email in the usual way whereby a user uses the web browser to read, compose, send, receive and manage emails. When a user wants to send a secure email message, the plain-text message is first sent from the web browser to the non-transient cryptographic engine (both at the client side) for encryption or signature insertion, or both. Then the secured message is transmitted to the server to be sent to the intended recipients. When a user retrieves a secure email message from the email server, the user can send the secured message to the non-transient cryptographic engine to perform decryption or signature verification, or both. Then the non-transient cryptographic engine sends the decrypted result to the web browser for display.

When a user replies to an incoming secure email, the user can choose to include the incoming email as a part of the outgoing email. By the time the user replies to a secure email message, the user would in most cases have decrypted the message through the non-transient cryptographic engine. The decrypted text is then included as a part of the outgoing email in the email compose page. After the user has finished composing the outgoing email message, and if the user elects to send this message in secure fashion, the email is sent to the non-transient cryptographic engine for encryption or signature insertion, or both. Finally the secured message is transmitted to the server for delivery to the intended recipients. In the case where a user wants to forward a secure email, the process will similarly go through the decryption, composition and encryption steps where the cryptographic procedures are performed by the non-transient cryptographic engine.

It is very important to note in all these cases (send new secure email, receive secure email, reply to secure email, and forward secure email) that all the security operations (encryption, decryption, signature insertion and verification) are performed by the non-transient cryptographic engine, which is located at the client side. Since the cryptographic operations are performed locally, end-to-end security is guaranteed.

In addition to providing the encryption, decryption, digital signature insertion and verification functions, the non-transient cryptographic engine can also serve as a key storage area, and performs a number of key management functions. Examples of these functions include key generation, import key, export key, delete key, send key by email, associate email address to key, remove an email address association from key, change passphase, and so on. The key management functions are handled by a combination of web browser and non-transient cryptographic engine, where the web browser provides the user interface, and the non-transient cryptographic engine performs the underlying cryptographic operations.

There are many possible embodiments for the non-transient cryptographic engine. For example, the non-transient cryptographic engine can be implemented as a software application that is permanently installed on the personal computer. The software application communicates with both the web browser and the email server using standard network protocols. In another embodiment it can be a piece of software placed on a piece of removable hardware that is plugged into a computer connector. When the user needs the security functions, the user plugs the hardware into a connecting port on the computer. This preferred embodiment of using a piece of removable hardware has an additional advantage that the user can bring this hardware anywhere he travels to. Since the user carries the key, other people will not be able to access his secured email messages even if the personal computer of the user has been broken into. These preferred embodiments only serve as examples of possible implementations. One who is skilled in the art can implement the non-transient cryptographic engine using many different hardware and/or software embodiments.

### BRIEF DESCRIPTION OF THE DRAWINGS

FIG. 1 is a system diagram of the web based secure email system, showing the server side components and the client side components.

FIG. 2 shows a server side architecture scaled up for handling a large number of web based secure email users.

FIG. 3 shows the data flow when sending a plain-text email versus sending a secure email.

FIG. 4 shows the data flow when receiving a plain-text email versus receiving a secure email.

FIG. 5 is a flow chart showing the composition and sending of plain-text and secure emails.

FIG. 6 is a flow chart showing uploading attachment procedures for both plain-text and secure modes in outgoing emails.

FIG. 7 is a flow chart of handling received plain text and secure email.

FIG. 8 is a flow chart of decryption and/or digital signature verification for downloaded attachment files.

### DETAILED DESCRIPTION OF THE PREFERRED EMBODIMENTS

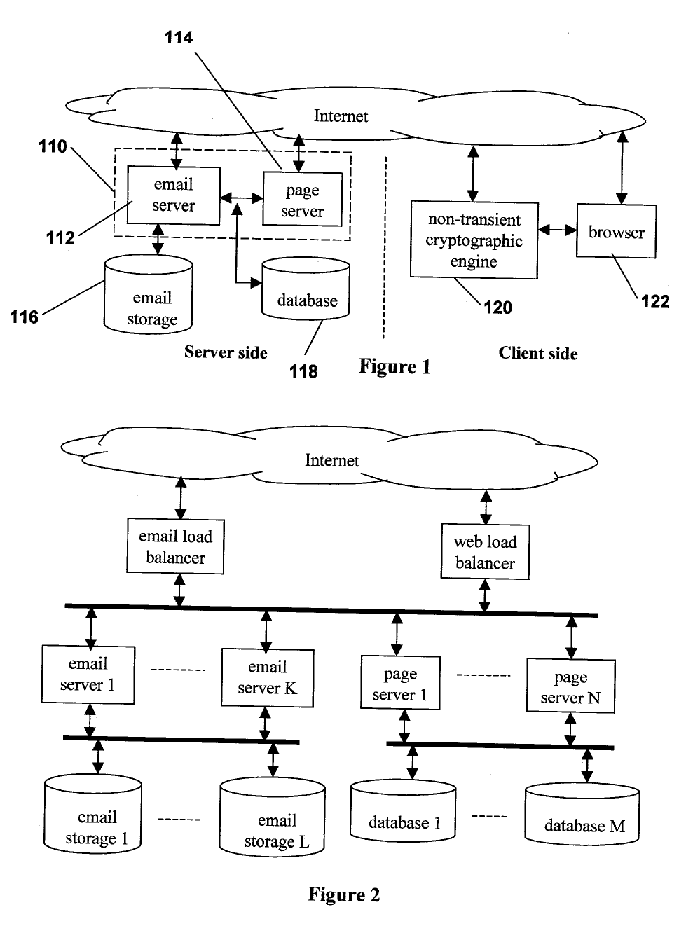

The present invention concerns a method for providing a web-based end-to-end secure email service. FIG. 1 illustrates a web-based end-to-end secure email system with a server 110 on the server side to provide standard web-based email services. The server contains an email server 112 to handle the email logic, and a web server 114 to provide pages to web browsers that presents a web based email service. In practical embodiments, the email server and the web server can be two different machines or can be the same machine with the appropriate software. The email server is connected to a storage device 116 for storing email messages for the users of the system. The server can be connected to an optional database device 118, which can store information such as user login data, subscription information, etc. On the client side, an email user needs a non-transient cryptographic engine 120 and a web browser 122. The non-transient cryptographic engine contains a means to perform security operations including encryption, decryption, digital signature insertion and verification. Depending on the amount of traffic for the service, one can scale up the server side by installing multiple email and web servers, distributed storage, and load balancers as illustrated in FIG. 2.

The art of scaling up the server side machinery for high traffic is well known. The non-transient cryptographic engine communicates with the web browser and the server to provide the security functions in an end-to-end secure web-based email system.

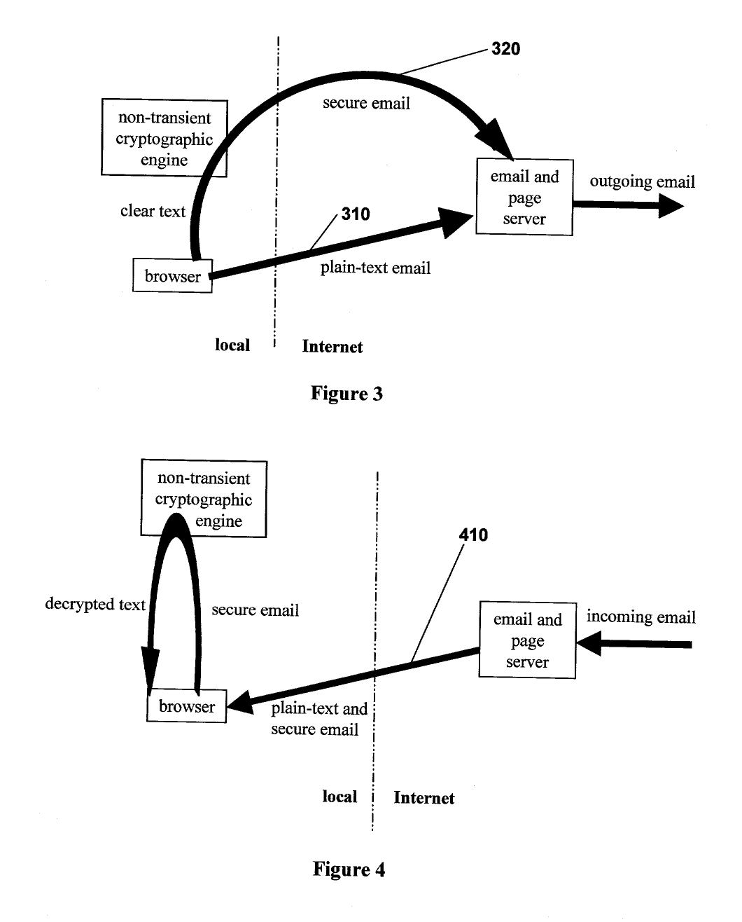

FIG. 3 shows the data flow when sending a plain-text email versus sending a secure email, and FIG. 5 shows the steps in a preferred embodiment to send plain-text as well as secure email messages. If a user wants to send a plain-text email, the user first goes to the email service web site and loads an email compose page. In step 502, a web browser displays the email compose page for the user. In step 504, the user types the text of the message. In the next step 506, the user decides whether there will be an attachment files included in the email. If there are attachments, the user executes step 510 for uploading attachment files, and then executes step 520. The details of step 510 will be discussed later. If there is no attachment files, the user jumps directly to step 520. In step 520, the user chooses whether the email should be encrypted and/or digitally signed. In a preferred embodiment of the user interface, these choices are made by selecting html check boxes on the web page. After the choice is made, the user executes the “send email” command in step 522. If the user selects to send a plain-text email, the web browser in step 530 sends the message via path 310 to the server, which will then process and send the message using normal email protocol. When the message is sent, the server sends an acknowledgement to the web browser in step 532.

If the user selects in step 520 to send an encrypted and/or digitally signed email, then the message follows path 320 from the web browser to the non-transient cryptographic engine and then to the server. Specifically, step 540 is executed after step 522. In step 540, the web browser sends the email message to the non-transient cryptographic engine. Then in step 542, the non-transient cryptographic engine performs the encryption and/or digital signature operation according to the user selection made in step 520. It is important to note that in public key cryptography, the decryption key (which is also used for digitally signing a message) is often protected by a passphase. Hence if a user selects to sign an outgoing email message, it is necessary for the user to provide the passphase to the local cryptography engine. In step 541 in our preferred embodiment, the web browser is used as the user interface for this purpose. Here the non-transient cryptographic engine sends a web form to the web browser whenever a passphase is required. Then the user types the passphase into the web form and submits the form to the non-transient cryptographic engine. Upon receiving the form, the non-transient cryptographic engine retrieves the passphase and signs the document.

When the security operations are completed, the non-transient cryptographic engine executes step 544 to send the encrypted and/or digitally signed message to the email server. This is followed by step 546 where the server sends the secure email to the recipients, and sends an acknowledgment to the non-transient cryptographic engine. In step 548, the non-transient cryptographic engine relays the acknowledgment to the web browser to be displayed to the user.

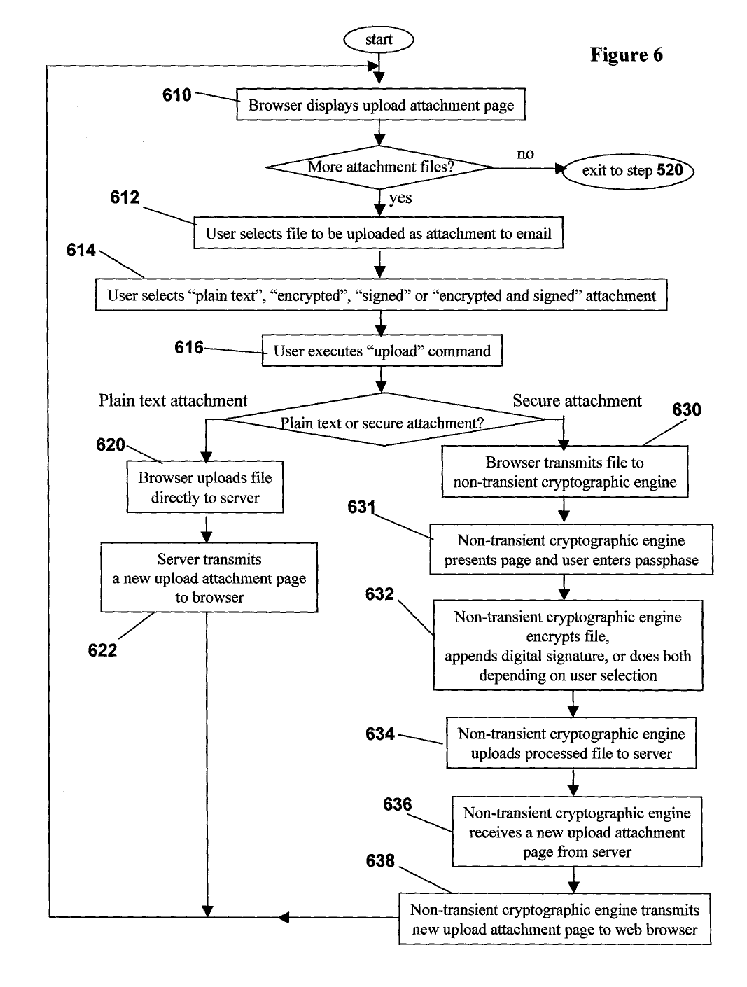

Now we examine in more detail a preferred embodiment for step 510 of FIG. 5 for uploading attachments. The steps are illustrated in FIG. 6. In a preferred embodiment, the user is presented with an “Edit attachment” button in the email compose form. When the user clicks on this button, step 610 is executed where an “upload attachment” page is displayed by the browser. This page contains control buttons for the user to select a file to be uploaded, as well as an interface for the user to delete attachment files that are previously uploaded but is no longer needed. If there is no more attachment files to be uploaded, the procedure exits to step 520 of FIG. 5. If the user wants to include an attachment in the email, the user selects in step 612 one or more files to be uploaded to the server as attachments in an email message. In step 614, the user selects whether the attachment file should be encrypted and/or digitally signed. In a preferred embodiment, this can be done using html check boxes. In step 616, the user executes the “upload” command by, for example, clicking a button on a web page. If the user selected to send the attachment in plain-text format, then the web browser uploads in step 620 the selected files directly to the server. Once the attachment files are uploaded, the server will include them in the outgoing email in the standard format. When the file uploading is completed, the web browser downloads a new upload attachment page in step 622 and then loops back to step 610.

If the user selected in step 614 to encrypt and/or digitally sign the upload files, then upon the user issuing the “upload attachment” command, the web browser executes step 630 to send the attachment files to the non-transient cryptographic engine. In the case where a user selected to sign an attachment file, a passphase is required. Then the non-transient cryptographic engine presents to the web browser in step 631 a page so that the user can enter the passphase. Upon receiving the passphase, the local cryptographic proceeds to digitally sign the attachment file. In step 632, the non-transient cryptographic engine encrypts and/or digitally signs the attachment files. In the next step 634, the processed attachment file is uploaded to the server. When this step is completed, the non-transient cryptographic engine receives in step 636 a new “upload attachment” page from the server. In step 638, the non-transient cryptographic engine sends the response to the browser to be displayed. Then the procedure loops back to step 610.

From the perspective of an email user, it is convenient to link the encryption and digital signature selection steps 520 and 614. Normally, when we want to send a secure email, we also want the attachment files to be secured. Similarly, we will likely want the attachment files to be in plain-text if the text content of the email is also in plain-text. In a preferred embodiment, we can use javascript code to link up the html checkbox selections in steps 520 and 614. For example, if the selection in step 520 is to encrypt the email text, then the selected option value is cross-linked to the “upload attachment” page, whereby the selection to encrypt the attachment files in step 614 is automatically made as a default. The reverse direction is also true in that if the user selects, for example, in step 614 to sign the attachment files, the main email text will automatically be signed unless the user specifically changes the selected option.

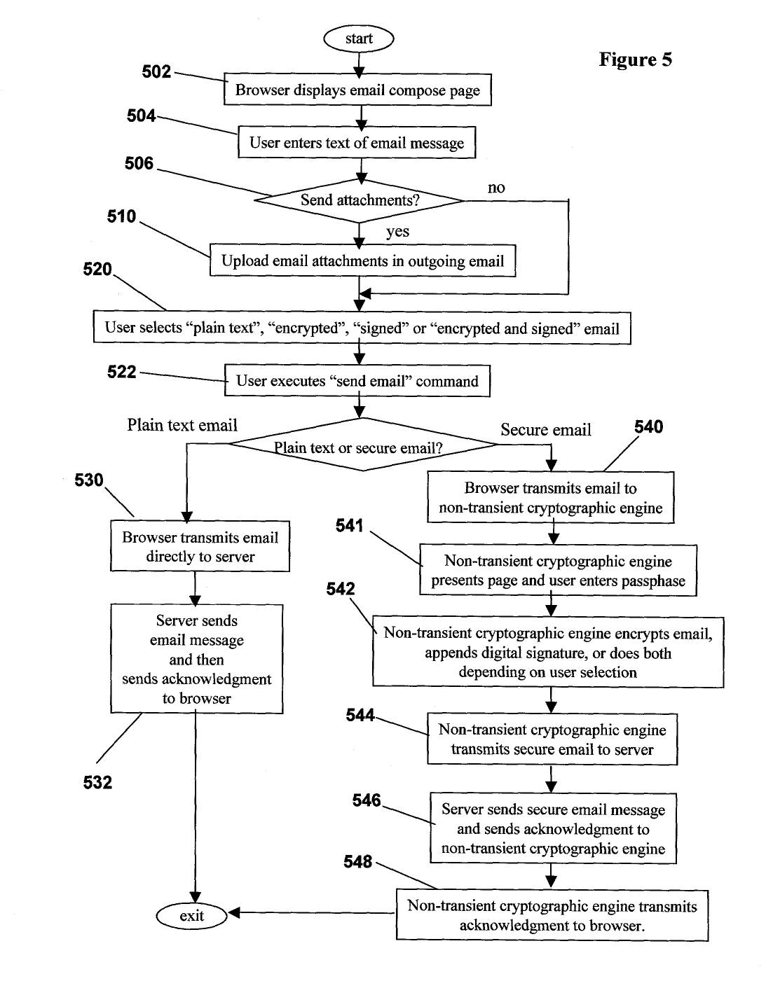

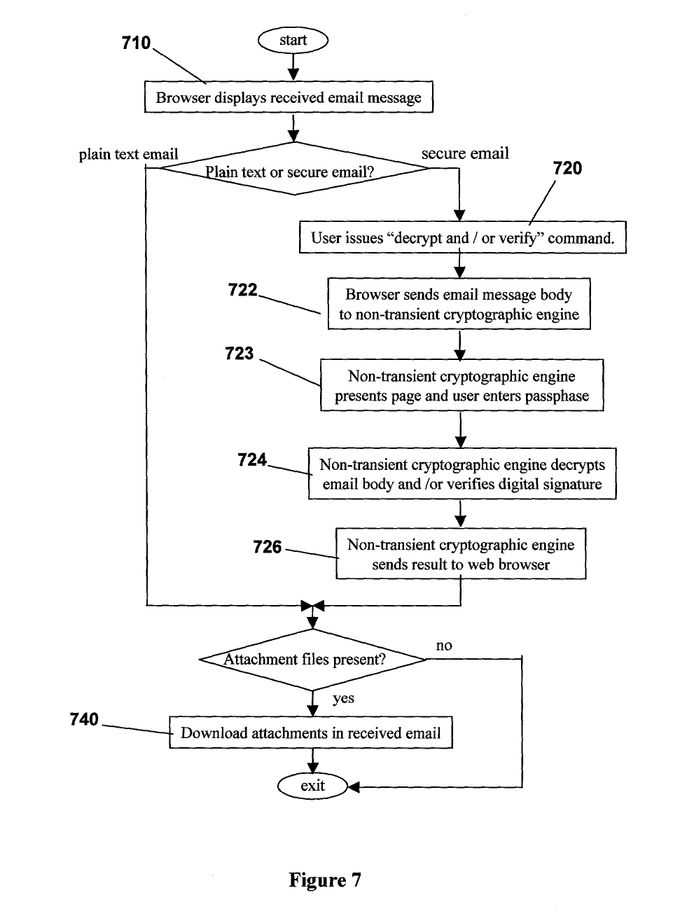

On receiving incoming emails, the system works in a way similar to existing web-based email systems. FIG. 7 shows the steps in receiving plain-text and secure email messages. In step 710, the browser downloads an incoming message and displays it to the user. The data goes through path 410 of FIG. 4 to travel from the server to the client machine. If an incoming message is in plain text, then the texts displayed in step 710 are sufficient for the email user to understand the content. Afterwards, the user goes to step 740 to download attachment files. In a preferred embodiment, the process of downloading an attachment file requires the user to click on an html link pointing to the attachment, and then selects a filename for the file to be saved.

If an incoming message is encrypted and/or signed, then the message displayed in step 710 will consists of encrypted text and/or containing a digital signature. To view the clear text message, the user goes to step 720 to issue a decrypt and/or verify digital signature command. In a preferred embodiment, the display message page provides a button “decrypt and verify”. When the user clicks this button, the secure message is transmitted from the browser to the non-transient cryptographic engine in step 722. The decryption operation often requires a passphase that protects the decryption key. In our preferred embodiment, the non-transient cryptographic engine presents a page in step 723 to the web browser so that the user can enter a passphase. In step 724, the non-transient cryptographic engine decrypts and/or verifies the digital signature.

When the decryption and/or signature verification steps are completed, we proceed to step 726 where the non-transient cryptographic engine sends the clear text message back to the browser for display. Step 740 of downloading attachment files is performed the same way whether the attachment files are in plain-text, encrypted, digitally signed, or both encrypted and signed. In a preferred embodiment, the downloaded attachment file is saved under a filename selected by the user. If the saved attachment files are encrypted and/or digitally signed, then we can invoke the non-transient cryptographic engine to perform decryption and/or signature verification.

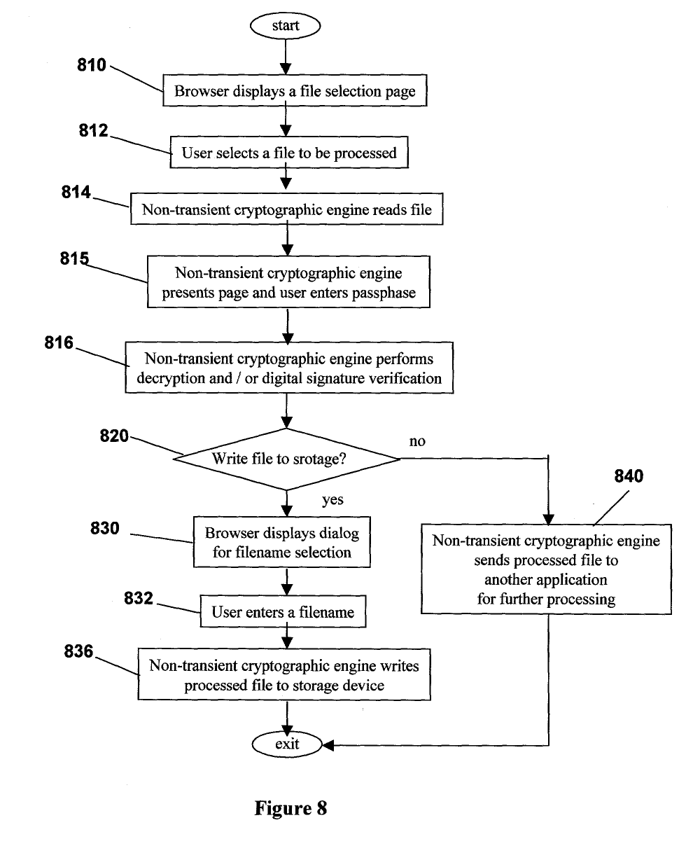

FIG. 8 shows the steps in a preferred embodiment for decrypting and/or verifying the signature in a downloaded attachment file. In step 810, the web browser displays an interface to the user for selecting a file to be processed. After the user has made a selection in step 812, the non-transient cryptographic engine reads the file from a storage device on the local computer in step 814. In step 815, the non-transient cryptographic engine presents a page for the user to enter a passphase for decryption purposes. In step 816, the non-transient cryptographic engine decrypts and/or verifies the digital signature in the file. In step 820, the user decides whether to save the processed file or send it to another application for further processing. If the user selects to save the file, then the browser displays a dialog in step 830 for filename selection. After the user has selected or entered a filename in step 832, the file is written to storage in step 836. On the other hand, if the user selected to send the processed the file to be processed by another application, the non-transient cryptographic engine forwards the file in step 840.

When a user replies to an incoming secure email, the user can choose to include the incoming email as a part of the outgoing email. By the time the user replies to a secure email message, the user will likely have decrypted the message using the non-transient cryptographic engine. The decrypted text is included as a part of the outgoing email in the email compose page. After the user has finished composing the outgoing email message, and if the user selects to send this message in secure fashion, the email is sent to the non-transient cryptographic engine for encryption and/or digital signature insertion. Finally the encrypted message is sent to the server for delivery to the intended recipients. In the case where a user wants to forward a secure email, the process similarly goes through the decryption, composition and encryption steps where the encryption and decryption procedures are performed by the non-transient cryptographic engine.

In addition to providing the encryption, decryption, digital signature addition and verification functions, the non-transient cryptographic engine can also be built to handle a number of key management functions. Examples of key management functions include key generation, import key, export key, delete key, send key by email, associate email address to key, remove an email address association with key, change pass phase, sign key and so on. The key management functions are handled by a combination of web browser and non-transient cryptographic engine, where the web browser provides the user interface, and the non-transient cryptographic engine performs the underlying cryptographic operations.

As an illustrative example of the key management functions for the non-transient cryptographic engine, consider an example where we want to generate a new public/secret key pair. In a preferred embodiment, the user invokes the key management page and then clicks a “Create Key” button on the key management page. This command is sent to the non-transient cryptographic engine, which then invokes the key generation mechanism within the engine. Specifically, it presents a new page that asks the identity of the user with whom the new key will be associated. In our illustrative example, the minimum required information includes the email address of the owner and a pass phase that will be associated with the new key. The user can also optionally provide the full name, a nickname, and other information. When these data is provided to the non-transient cryptographic engine through the web-based interface, the non-transient cryptographic engine proceeds to generate a new key and then save it. In a preferred embodiment, the key will be put into a “key ring” which is a special file for storing the keys. This example illustrates a design where the key management functions are implemented in the non-transient cryptographic engine, whereas the user interface is provided by the web browser.

An important advantage of this design is that all the security operations are executed locally at the non-transient cryptographic engine. In sending secure emails, the plain text of an encrypted email is never seen by the server. Similarly in receiving secure emails, the encrypted text is also not available on the server side as the email is decrypted locally. This guarantees end-to-end security to the email user.

Another advantage of this design is that the cryptographic engine is non-transient and it resides on the client side. Hence the cryptographic functions are readily available for user. In this design, there is no need to download an applet or other cryptographic software when a user logs into the system. This means that the latency of the system is very low.

A further advantage of this design is that the non-transient cryptographic engine can be implemented in many forms, either in hardware, software, or a combination of the two. The implementation can be done in many ways in native code of the client system. This provides high-speed operation compared to systems that require an interpreted language such as java applets.

The fourth advantage of this design is that the non-transient cryptographic engine can be realized as a portable and removable device that the email user carries. As a result, the user can access the web-based secure email service on any networked computer from anywhere. Furthermore, since the keys is stored on keyrings within the non-transient cryptographic engine, the email user can be assured that his secured email messages will not be accessible by any other person, even in the case that the computer of the person has been broken into.

The fifth advantage of this design is that the non-transient cryptographic engine and the server perform distinct functions, and hence they are simple to construct. In sending email, the non-transient cryptographic engine handles encryption and digital signature operations, whereas the server constructs the email from the components including the email addresses of the “to”, “cc” and “bcc” recipients, the subject of the email, the text body of the email, and any attachment files. In other words, the server handles the components in the same way whether the email text and the attachment files are encrypted or not. On the other hand, the non-transient cryptographic engine simply takes the data from the browser, and encrypts and/or digitally signs them, and passes them all to the web server. The non-transient cryptographic engine does not need to know how an email is constructed from its components. Similarly in the case of receiving incoming emails, all the logic for managing the messages as well as for displaying the message list and message body is handled by the server. The non-transient cryptographic engine only needs to handle the decryption and signature verification procedures when instructed by the browser.

As seen in FIG. 1 for a preferred embodiment, the server consists of a web server and an email server. Since the email server handles standard email functions, we can use any existing email server that understands standard email protocols. Similarly we can use any web server that can handle standard http. All we need to do is to change the web pages and its underlying logic to handle the user interface.

The sixth advantage is that the server and the web browser combined can handle plain text email without the non-transient cryptographic engine. Hence, for example, if a user forgets to carry the non-transient cryptographic engine, the user will still be able to send and receive plain text email. Since the non-transient cryptographic engine only handles the security operations, we only lose the capability to perform security operations if we do not carry the non-transient cryptographic engine. Ordinary email functions are still available. This is a graceful degradation property of our secure email system design.

We have described the addition of a non-transient cryptographic engine to a web based email system so that the system can support web-based secure email with end-to-end security. We have described a preferred embodiment of this invention. The description will allow people with ordinary skill in the art to construct a similar secure email system using a non-transient cryptographic engine. Therefore the preferred embodiment is meant to be an example for illustrating the key components of the invention and should not be taken as the only embodiment that is possible with this invention.

What is claimed is:

1. A method of providing a browser based electronic messaging service comprising the following steps:
i. providing an electronic messaging server for sending and receiving electronic messages in the global computer network,
ii. providing a page server for presenting pages to a browser application that presents an electronic messaging service,
iii. providing a browser application on the client side,
iv. providing a non-transient cryptographic means on the client side for performing cryptographic operations.

2. The method of claim 1 where said non-transient cryptographic means is software installed on a computer on said client side.

3. The method of claim 1 where said non-transient cryptographic means is a piece of removable hardware that connects to a computer on said client side.

4. The method of claim 1, with a method for sending said electronic message in secure format comprising the following steps:
i. sending said electronic message to said non-transient cryptographic means,
ii. performing, at said non-transient cryptographic means, encryption, or digital signature insertion, or both encryption and digital signature insertion,
iii. sending said processed secure message to said page server.

5. The method of claim 1, with a method for receiving said electronic message in secured format comprising the following steps
i. receiving, at said browser application, said secure electronic message from said page server,
ii. sending said secure electronic message to said non-transient cryptographic means,
iii. performing, at said non-transient cryptographic means, decryption, or digital signature verification, or both decryption and digital signature verification,
iv. sending, from said non-transient cryptographic means, said processed message for display, storage, or further processing.

6. The method of claim 1, where a method of sending said electronic message includes the function of sending secure attachments, comprising the steps of
i. presenting an interface for a user to select a file to be uploaded to said server,
ii. sending said selected file to said non-transient cryptographic means for encryption, digital signature insertion, or both encryption and digital signature insertion,
iii. sending said processed file to said page server.

7. The method of claim 1, where a method of receiving said electronic message includes the function of receiving secure attachments, comprising the steps of
i. downloading said secure attachment file to said client side,
ii. sending said downloaded secure attachment file to said non-transient cryptographic means,
iii. performing, at the non-transient cryptographic means, decryption, or digital signature verification, or both decryption and digital signature verification for said attachment file.

8. The method of claim 1 where said non-transient cryptographic means includes means to perform a key management function.

9. The method of claim 1 where said non-transient cryptographic means stores identification information for a user to access said secure electronic messaging system.

10. The method of claim 1 where said non-transient cryptographic means includes a means to store the key of a recipient of said electronic message.

11. The method of claim 1 where said page server and said browser application communicates in the hyper-text transfer protocol (http).

12. A browser-based secure electronic messaging system comprising
i. an electronic messaging server for sending and receiving electronic messages in the global computer network,
ii. a page server that communicates with said electronic messaging server, and provides pages to a client for presenting an electronic messaging service,
iii. a client having a browser application, and
iv. said client having a non-transient cryptographic means for performing cryptographic operations, as well as for communicating with said browser application and said server.

13. The system of claim 12 where said non-transient cryptographic means is software installed on a computer on said client side.

14. The system of claim 12 where said non-transient cryptographic means is a piece of removable hardware that connects to a computer on said client side.

15. The system of claim 12 where said non-transient cryptographic means includes means to perform a key management function.

16. The system of claim 12 where said non-transient cryptographic means stores identification information for a user to access said secure electronic messaging system.

17. The system of claim 12 where said non-transient cryptographic means includes a means to store the key of a recipient of said electronic message.

18. The system of claim 12 where said page server and said browser application communicates in http.

19. A web-based secure email system comprising
i. an email server on the server side to provide the capability to send and receive email messages in the global computer network,
ii. a web server on the server side to provide pages to a web browser on the client side, presenting a web based email service,
iii. a computer on the client side with a web browser,
iv. a non-transient cryptographic means on the client side to perform cryptographic functions and key management functions for securing email messages.

20. The system of claim 19 where said non-transient cryptographic means includes a means of performing key management functions and for key storage.
